(19) United States
(12) Patent Application Publication
(10) Pub. No.: US 2023/0332650 A1
(43) Pub. Date: Oct. 19, 2023

(54) FRICTION PART

(71) Applicant: Schaeffler Technologies AG & Co. KG, Herzogenaurach (DE)

(72) Inventor: Johannes Bernhardt, Bühl (DE)

(73) Assignee: Schaeffler Technologies AG & Co. KG, Herzogenaurach (DE)

(21) Appl. No.: 18/024,785

(22) PCT Filed: Aug. 3, 2021
(86) PCT No.: PCT/DE2021/100667

§ 371 Date: Mar. 6, 2023

(30) Foreign Application Priority Data
Sep. 8, 2020 (DE) 10 2020 123 412.0

(51) Int. Cl. F16D 13/64; F16D 13/68

(52) U.S. Cl. CPC F16D 13/648; F16D 13/683; F16D 2300/12

(57) ABSTRACT

A friction part includes a circular ring disk-like friction body with a friction surface, a coupling body connected as a single piece to the circular ring disk-like friction body, and a weakened region. The coupling body has a toothing arranged to provide a rotationally fixed connection to a disk carrier. Circumferential rigidity of the friction part is reduced in the weakened region to facilitate compensating circumferential movements between sections of the friction part adjoining the weakened region.

### CROSS-REFERENCE TO RELATED APPLICATIONS

This application is the United States National Phase of PCT Appln. No. PCT/DE2021/100667 filed Aug. 3, 2021, which claims priority to German Application No. DE1020202123412.0 filed Sep. 8, 2020, the entire disclosures of which are incorporated by reference herein.

### TECHNICAL FIELD

The present disclosure relates to a friction part with a circular ring disk-like friction body, which has at least one friction surface, and with a coupling body which is used to produce a rotationally fixed connection to the friction part.

### BACKGROUND

Friction parts for use in clutches or brakes are known in a variety of embodiments for both wet and dry applications. For example, a friction plate for wet friction clutch modules for use in automotive powertrains is known from European patent specification EP 1 910 704 B1. From German patent application DE 10 2011 086 523 A1, a friction body is known which can be connected to a friction body carrier. From German patent application DE 10 2016 203 048 A1, a lining carrier for at least one wet friction lining is known, which is formed from a wet friction lining material, the lining carrier comprising a dry friction lining material. From the German patent application DE 10 2018 124 338 A1, a friction disk with a friction body is known, which has at least one friction surface, the friction body being connected to the coupling body in a form-fitting manner.

### SUMMARY

The present disclosure provides a friction part with a circular ring disk-like friction body, which has at least one friction surface, and with a coupling body, which is used to produce a rotationally fixed connection to the friction part, in that the friction part includes at least one weakened region in which the rigidity of the friction part is reduced in the circumferential direction in a controlled manner such that compensating movements are facilitated between two friction part sections adjoining the weakened region in the circumferential direction. The friction part may be a friction disk, e.g., a clutch disk or a brake disk. The coupling body may be a toothing, for example an internal toothing or an external toothing, which is formed on the friction part. The coupling body, e.g., the toothing, can be formed radially inside or radially outside on the circular ring disk-like friction body. The circular ring disk-like friction body can be attached to a carrier element, for example a carrier plate. In the case of conventional friction disks, the coupling body, e.g., the toothing, is usually formed on the carrier element. In the case of the claimed friction part, the coupling body, e.g., the toothing, can be formed both on the circular ring disk-like friction body and on the carrier element.

In one embodiment of the friction part, the friction part is designed without a carrier element. In an exemplary embodiment, the coupling body is integrally connected, e.g., as a single piece, to the circular ring disk-like friction body. The weakened region of the friction part may produce a flexure beam or a flexure joint in order to facilitate the desired compensating movements. For this purpose, the ring structure of the friction part is partially separated or interrupted in the radial direction. In this way, a tangential rigidity of the friction part can be reduced in a controlled manner. The reduction in the rigidity of the lining structure in the tangential direction can go so far that the friction part is divided into circular ring disk-like friction bodies or segments. When torque is transmitted, the compensating movements facilitate a defined introduction of force into the friction part or from the friction part, for example into a disk carrier which is connected to the friction part in a rotationally fixed manner.

In an exemplary embodiment of the friction part, the friction body is connected to the coupling body as a single piece. In this way, the weight and the mass inertia of the friction part can be reduced. In addition, the production costs can be reduced because a carrier element, e.g., a carrier plate, can be omitted. Furthermore, the assembly of the friction part is simplified. If the friction part is formed from an organic material, any post-processing that would otherwise be required can be omitted.

In another embodiment of the friction part, the friction part is attached to a carrier element. The carrier element is, for example, a carrier plate. If the friction body is connected as a single piece to the coupling body, then the carrier element, e.g., the carrier plate, can simply be designed as a circular ring disk, e.g., without toothing. Depending on the design, the carrier element can however also be designed with a toothing. The friction body is, for example, connected to the carrier element in a bonded manner. The bonded connection can be specifically designed to be so elastic that relative movements between the friction body and the carrier element are facilitated in order to allow the compensating movements described above. Depending on the design, however, the carrier element can also be designed with the same or similar weakened regions as the friction body.

In a further exemplary embodiment of the friction part, the circular ring disk-like friction body has at least one recess which extends outwards from a radially inner peripheral edge of the friction part. The recess, which is embodied, for example, as a groove or as a slot in the circular ring disk-like friction body, may extend radially outwards from the radially inner peripheral edge of the friction part. Depending on the design, the recess can also extend obliquely to a radial line.

In a further exemplary embodiment of the friction part, the circular ring disk-like friction body has at least one recess which extends inward from a radially outer peripheral edge of the friction part. The recess, which is designed, for example, as a groove or as a slot in the circular ring disk-like friction body, may extend radially inward. However, the recess can also extend obliquely to a radial line.

In another embodiment of the friction part, two recesses are arranged on a common radial line and facing each other. A remaining bridge between the recesses may produce a flexure joint between the friction lining sections adjoining in the circumferential direction. In this way, the desired compensating movements can be facilitated with little manufacturing effort.

In a further exemplary embodiment of the friction part, two recesses are offset in a circumferential direction and arranged in an overlapping manner in the radial direction. A remaining bridge between the recesses produces a flexure beam, which facilitates the desired compensating movements between the friction part sections adjoining in the circumferential direction. The recesses are easy to produce in terms of manufacturing technology.

In the case of a friction part with a circular ring disk-like friction body which has at least one friction surface, and with a coupling body which is used to produce a rotationally fixed connection to the friction part, in particular in the case of a friction part described above, the circular ring disk-like friction body may be divided into friction lining pieces, which are each connected as a single piece to a coupling body part. The friction part may have at least two friction lining pieces. The coupling body part is, for example, at least one tooth of a toothing for producing a rotationally fixed connection to a disk carrier. The toothing may be designed as external teeth on the friction part. Here, a connection between the individual friction lining pieces is not required if the friction lining pieces are mounted, for example, in a disk carrier that is designed in a correspondingly complementary manner. In this way, the desired compensating movements can be implemented in a simple manner. Depending on the design, however, the friction lining pieces can also be partially connected to one another. This connection can be made as a single piece. However, the friction lining pieces can also be attached to a carrier element, such as a carrier plate. The friction lining pieces may be in the form of circular ring sectors or segments.

In a further exemplary embodiment of the friction part, the friction lining pieces may each have only two tooth flanks in order to produce the coupling region. The tooth flanks produce part of a toothing in the coupling region. The tooth flanks can be formed on one tooth per friction lining piece. During operation of the friction part, the two tooth flanks engage in a form-fitting manner in a corresponding toothing of the disk carrier. The tooth flanks can be provided both centrally but also on tangential end faces of the coupling body.

In a further exemplary embodiment, two adjoining friction lining pieces are connected to one another by a flexure joint or a flexure beam. Here, the friction lining pieces remain connected to one another. This simplifies handling of the friction part during assembly.

The present disclosure further relates to a clutch or a brake, e.g., a multi-disk clutch or a multi-disk brake, with at least one friction part described above, e.g., with a plurality of such friction parts. The clutch or brake may be operated dry. At least two of the exemplary embodiments described above can also be combined in the clutch or brake. For example, a ring structure can be separated into at least two elements, which are then connected by a joint or flexure beam to increase flexibility.

### BRIEF DESCRIPTION OF THE DRAWINGS

Further advantages, features and details of the disclosure will be apparent from the following description, in which various exemplary embodiments are described in detail with reference to the drawing. In the figures:

FIG. 1 shows a schematic representation of a half section of a frictionally working device designed as a wet multi-disk clutch;

FIG. 2 shows a schematic representation of a friction part, which comprises two weakened regions, according to a first exemplary embodiment, in plan view;

FIGS. 3 and 4 show representations similar to those in FIG. 2 according to further exemplary embodiments;

FIGS. 5 and 6 show friction lining pieces according to two further exemplary embodiments, also in plan view; and

FIGS. 7 to 9 show various representations of a friction part similar to that in FIG. 1 according to a further exemplary embodiment; in particular to illustrate a joint function on the friction part and an ovalization facilitated as a result.

### DETAILED DESCRIPTION

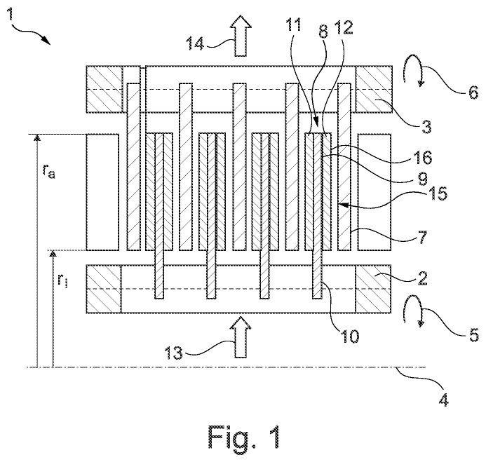

In FIG. 1, a half section of a frictionally working device designed as a wet multi-disk clutch 1 is shown schematically. The wet multi-disk clutch 1 comprises an inner disk carrier 2 and an outer disk carrier 3. The two disk carriers 2, 3 can be rotated relative to one another about an axis of rotation 4 independently of one another at different rotation speeds, which are indicated by arrows 5, 6.

A disk pack of the wet multi-disk clutch 1 comprises steel disks 7 and lined disks 8. The lined disks 8 each comprise a lining carrier 9 which is connected to the inner disk carrier 2 in a rotationally fixed manner radially on the inside of a coupling region 10. The coupling region 10 of the lining carrier 9 is designed, for example, as an internal toothing that is mounted with a complementary external toothing of the inner disk carrier 2. Similarly, the steel disks 7 are connected to the outer disk carrier 3 in a rotationally fixed manner, radially on the outside.

Friction linings 11, 12 are attached on both sides of the lining carrier 9, i.e., on the left and right in FIG. 1. The design and function of a wet multi-disk clutch 1 are known per se and will not be explained further here. An arrow 13 indicates a cooling and/or lubricating medium which enters the disk pack of the wet disk clutch 1, radially on the inside through the inner disk carrier 2. An arrow 14 indicates that the cooling and/or lubricating medium exits the outer disk carrier 3 radially on the outside.

The cooling and/or lubricating medium is primarily used for cooling in the wet multi-disk clutch 1. The lined disk 8 with the lining carrier 9 and the two friction linings 11, 12 is also referred to as the friction part 15. The friction part 15 has a friction surface 16 shown on the right in FIG. 1, facing the steel disk 7.

The friction surface 16 is delimited radially on the inside by an inner radius ri. The friction surface 16 is delimited radially on the outside by an outer radius ra. On the left of FIG. 1, the friction part 15 comprises a further friction surface, not designated in any further detail, which faces the adjoining steel disk. For torque transmission, the friction part 15 can be clamped with its circular ring disk-like friction surfaces 16 in each case between two adjoining steel disks 7.

The wet-multi-disk clutch 1 shown in FIG. 1 can, in contrast to what is shown, also be designed to run dry. During operation of the multi-disk clutch 1, the plates are subjected to a contact pressure in the axial direction. In the tribological contact between the lined disks and steel disks, torque is transmitted by friction. The torque is introduced into the inner disk carrier 2 or the outer disk carrier 3 via the drive teeth.

FIGS. 1 to 9 show various embodiments of a friction part 101; 21, 22; 31 and 41, each shown in plan view and partially cut away. The friction part 101; 21, 22; 31 and 41 includes a friction body 102 and a coupling body 104. The friction body 102 essentially has the shape of a circular ring disk. The friction surface 103 has the shape of a circular ring surface.

The coupling body 104 is designed as a toothing 105. The toothing 105 is shown on the friction part 101; 21, 22; 31 and 41 designed as external toothing. Parts of the toothing 105 shown by way of example are referred to as internal tooth 106 and internal tooth 107. The toothing 105 is used for the rotationally fixed connection to the outer disk carrier (3 in FIG. 1) of the multi-disk clutch.

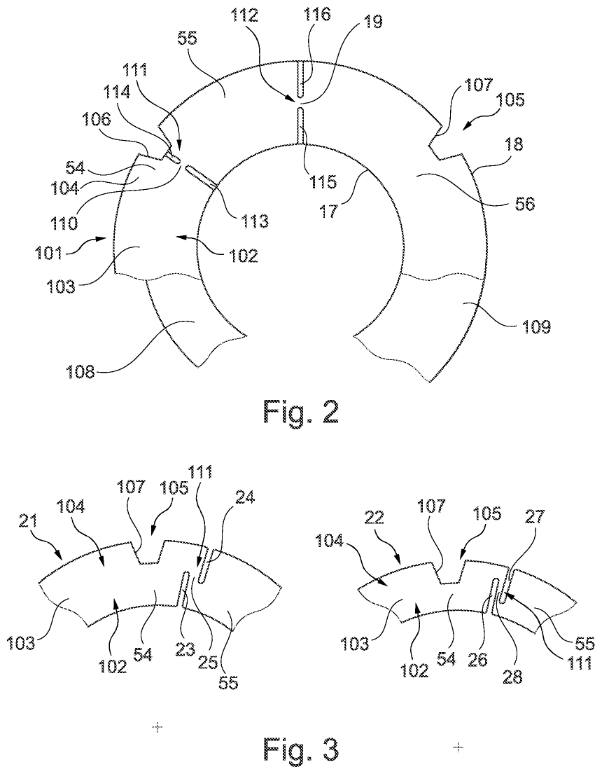

The same reference signs are used in FIGS. 2 to 9 to designate the same or similar parts. Similarities between the various exemplary embodiments are only described once.

FIG. 2 indicates that the friction body 102 may be attached on a carrier element 108; 109. The carrier element 108; 109 is, for example, a carrier plate. The carrier plate can have the same inner diameter as the friction body 102. The carrier plate can also have the same outside diameter as the friction body 102. However, the carrier plate can also have a smaller outside diameter than the friction body 102.

The coupling body 104 or the toothing 105 is connected as a single piece to the friction body 102.

Two weakened regions 111, 112 on the friction part 1 are indicated in FIG. 2. In the weakened regions 111, 112, the rigidity of the friction part 101, in particular of the friction body 102, is reduced in a controlled manner in the circumferential direction.

Two slot-like or groove-like recesses 113, 114 are used to produce the weakened region 111. The recesses 113, 114 extend towards one another in the radial direction from the inner peripheral edge 17 or from the outer peripheral edge 18, respectively. A remaining distance or bridge between the recesses 113, 114 produces a flexure joint 110.

The weakened region 112 includes similar recesses 115, 116. The main difference between the weakened regions 111, 112 is that the recess 114 in FIG. 2 does not extend radially inward directly from the outer peripheral edge 18 but rather from a tooth base of the internal tooth 106.

The weakened region 112 is used to produce a flexure joint 19 on the friction body 2. The flexure joints 110, 19 produce single-piece connections between friction part sections or friction lining pieces 54, 55 and 55, 56. Desired compensating movements between the friction part sections or friction lining pieces 54, 55 and 55, 56 are facilitated by the flexure joints 110;19.

FIG. 3 shows two sections of friction parts 21, 22 with similar recesses 23, 24 and 26, 27, which, as in FIG. 2, are used to produce a weakened region 111 in the friction body 102.

The recesses 23, 24; 26, 27 are offset from one another in the circumferential direction and overlapping in the radial direction. This results in a flexure beam 25; 28 between two adjoining friction part sections or friction lining pieces 54, 55. The desired compensating movements between the friction part sections or friction lining pieces 54, 55 can be adjusted in a controlled manner via the shape and size of the flexure beam 25; 28.

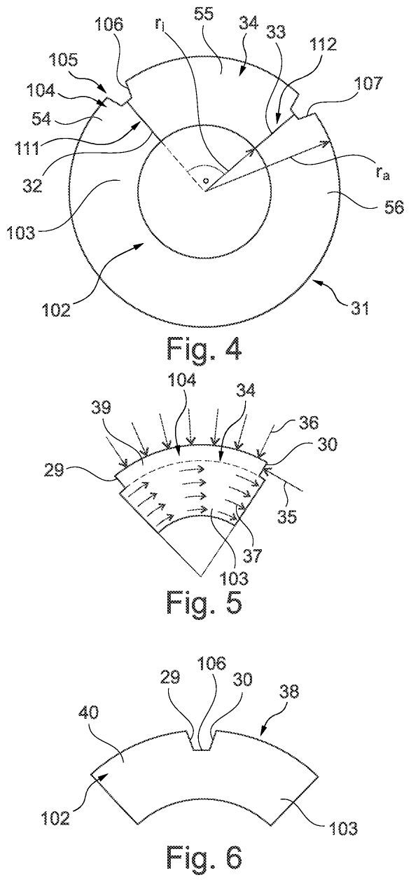

In the case of the friction part 31 shown in FIG. 4, a friction lining piece 34 is delimited by two recesses 32, 33. The recesses 32, 33 are designed, for example, as slits that extend in the radial direction. This results in a circular ring sector-like friction lining piece, which is also referred to as a segment. An inner diameter ri is indicated by an arrow. An outer diameter ra of the friction part 31 is indicated by a further arrow.

In FIG. 4, a right angle is provided between the recesses 32, 33 and between the internal toothings 106, 107. Other angles can also be advantageous under other boundary conditions, which relate, for example, to the coefficient of friction, the inner radius or the outer radius.

FIG. 5 shows the friction lining piece 34 alone, with arrows 35, 36, 37 to illustrate the forces acting during operation. The coupling body 104 is delimited by two tooth flanks 29, 30 in the circumferential direction. A force 35 for torque transmission acts on the tooth flank 30. The arrows 36 illustrate supporting forces that serve to radially support the friction lining piece 34 in the outer disk carrier (3 in FIG. 1). The arrows 37 illustrate the frictional forces acting during operation. The force 35 acts purely tangentially in FIG. 5.

The region between the tooth flanks 29, 30 produces a coupling body part 39 on the coupling body 104. FIG. 6 shows that a coupling body part 40 of the coupling body 102 can also be equipped with an internal tooth 106 which is delimited by two tooth flanks 29, 30. In FIG. 6, on the friction lining piece 38, it is shown that the coupling body 102 can also be equipped with an internal tooth 106, which is limited by two tooth flanks 29, 30.

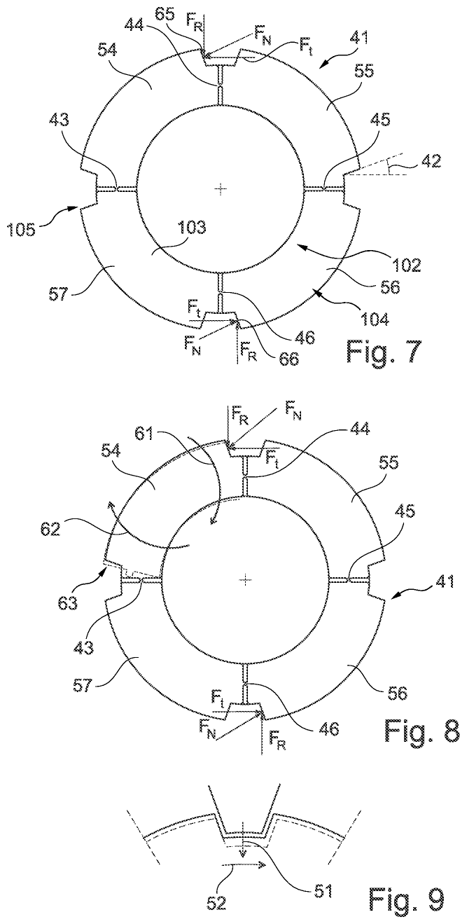

The compensating movements on the friction part 41 are illustrated in FIGS. 7 to 9. The friction part 41 is indicated by an arrow and Ft, FN and FR are tangential forces, normal forces and radial forces. Reference sign 42 indicates a flank angle of a tooth flank in the toothing that produces the coupling body 104. The friction part 41 comprises a total of four weakened regions 43 to 46 which are distributed evenly in the circumferential direction. The weakened regions 43 to 46 divide the friction part 41 with the friction body 102 into a total of four friction part sections or friction lining pieces 54 to 57.

FIG. 7 illustrates that an unwanted pitch error in the toothing 105 on the friction part 41 can result in only two tooth flanks 65, 66 bearing load. The torque to be transmitted is supported on the tooth flanks 65, 66 via tangential forces Ft. The flank angle 42 results in radial forces FR. The radial forces FR lead to an ovalization of the friction body 102, which is ring-shaped per se, as indicated by arrows 61 and 62 in FIG. 8. The weakened regions 43, 44 facilitate the desired compensating movements. The new position of the friction lining piece 54 is indicated at 63 by dashed lines.

An arrow 51 in FIG. 9 indicates that load-bearing tooth flanks are moved radially inwards. A deformation in the radial direction, in combination with the flank angle (42 in FIG. 7), facilitates a tangential movement indicated by an arrow 52 in FIG. 9. Due to the rotating of the friction part 41 resulting from this, an undesired toothing play of non-load-bearing teeth can be reduced. Non-load-bearing teeth are moved outwards so that the toothing play is reduced due to the ovalization. In this way, the introduction of force for the transmission of the torque can be homogenized, preferably up to an even load of all teeth of the toothing 105.

### REFERENCE NUMERALS

1 Wet. multi-disk clutch
2 Inner disk carrier
3 Outer disk carrier
4 Axis of rotation
5 Rotation speed
6 Rotation speed
7 Steel disk
8 Lined disk
9 Lining carrier
10 Coupling region
11 Friction lining
12 Friction lining
13 Arrow
14 Arrow
15 Friction part
16 Friction surface
17 Inner peripheral edge
18 Outer peripheral edge
19 Flexure joint
21 Friction part
22 Friction part
23 Recess
24 Recess
25 Flexure beam
26 Recess
27 Recess
28 Flexure beam
29 Tooth flank
30 Tooth flank
31 Friction part
32 Recess
33 Recess
34 Friction lining piece
35 Arrow
36 Arrows
37 Arrows
38 Friction lining piece
39 Coupling body part
40 Coupling body part
41 Friction part
42 Flank angle
43 Weakened region
44 Weakened region
45 Weakened region
46 Weakened region
51 Arrow
52 Arrow
54 Friction part section, friction lining piece
55 Friction part section, friction lining piece
56 Friction part section, friction lining piece
57 Friction part section, friction lining piece
61 Arrow
62 Arrow
63 Ovalization
65 Tooth flank
66 Tooth flank
101 Friction part
102 Friction body
103 Friction surface
104 Coupling body
105 Toothing
106 Internal toothing
107 Internal toothing
108 Carrier element
109 Carrier element
110 Flexure joint
111 Weakened region
112 Weakened region
113 Recess
114 Recess
115 Recess
116 Recess

1. A friction part having a circular ring disk-like friction body and a coupling body, the circular ring disk-like friction body comprising a friction surface, and the coupling body being used to produce a rotationally fixed connection, wherein the friction part further comprises at least one weakened region in which a rigidity of the friction part is reduced in a circumferential direction in a controlled manner such that compensating movements are facilitated between two friction part sections adjoining the weakened region in the circumferential direction.

2. The friction part according to claim 1, wherein the circular ring disk-like friction body is connected as a single piece to the coupling body.

3. The friction part according to claim 1, wherein the circular ring disk-like friction body is attached to a carrier element.

4. The friction part according to claim 1, wherein the circular ring disk-like friction body comprises at least one recess which extends outward from a radially inner peripheral edge of the friction part.

5. The friction part according to claim 1, wherein the circular ring disk-like friction body comprises at least one recess which extends inward from a radially outer peripheral edge of the friction parts.

6. The friction part according to claim 1, wherein the circular ring disk-like friction body comprises two recesses arranged on a common radial line and facing one another.

7. The friction part according to claim 1, characterized in that wherein the circular ring disk-like friction body comprises two recesses offset in the circumferential direction and arranged in an overlapping manner in a radial direction.

8. The friction part according to of claim 1, wherein the circular ring disk-like friction body is divided into friction lining pieces which are each connected as a single piece to a coupling body part.

9. The friction part according to claim 8, wherein the friction lining pieces each have only two tooth flanks producing a coupling region.

10. The friction part according to claim 8, wherein two adjoining friction lining pieces are connected to one another by a flexure joint or a flexure beam.

11. A friction part comprising:
a circular ring disk-like friction body comprising a friction surface;
a coupling body connected as a single piece to the circular ring disk-like friction body, the coupling body comprising a toothing arranged to provide a rotationally fixed connection to a disk carrier; and
a weakened region in which circumferential rigidity of the friction part is reduced to facilitate compensating circumferential movements between sections of the friction part adjoining the weakened region.

12. The friction part of claim 11 wherein the weakened region comprises a recess extending radially outward from a radially inner peripheral edge of the friction part.

13. The friction part of claim 11 wherein the weakened region comprises a recess extending radially inward from a radially outer peripheral edge of the friction part.

14. The friction part of claim 11 wherein the weakened region comprises:
a first recess extending radially outward from a radially inner peripheral edge of the friction part; and
a second recess extending radially inward from a radially outer peripheral edge of the friction part, wherein the first recess and the second recess are arranged on a common radial line and face one another.

15. The friction part of claim 11 wherein the weakened region comprises:
a first recess extending radially outward from a radially inner peripheral edge of the friction part; and
a second recess extending radially inward from a radially outer peripheral edge of the friction part, wherein the first recess and the second recess are offset in a circumferential direction and arranged in an overlapping manner in a radial direction.

16. The friction part of claim 11, wherein the circular ring disk-like friction body is divided into friction lining pieces.

17. The friction part of claim 16 wherein the toothing of the coupling body of each friction lining piece comprises exactly two tooth flanks.

18. The friction part of claim 16 wherein adjoining friction lining pieces are connected to one another by a flexure joint or a flexure beam.
